(19) United States
(12) Patent Application Publication
(10) Pub. No.: US 2024/0421571 A1
(43) Pub. Date: Dec. 19, 2024

(54) WIRING MEMBER

(71) Applicant: Sumitomo Wiring Systems, Ltd., Yokkaichi-shi, Mie (JP)

(72) Inventors: Kosuke UCHIDA, Yokkaichi-shi, Mie (JP); Kyungwoo KIM, Yokkaichi-shi, Mie (JP); Toshinari KOBAYASHI, Yokkaichi-shi, Mie (JP); Moriyuki SHIMIZU, Yokkaichi-shi, Mie (JP); Daichi CHIBA, Yokkaichi-shi, Mie (JP); Wataru TOKAIRIN, Yokkaichi-shi, Mie (JP); Hironobu YAMAMOTO, Yokkaichi-shi, Mie (JP)

(73) Assignee: Sumitomo Wiring Systems, Ltd., Yokkaichi-shi, Mie (JP)

(21) Appl. No.: 18/704,258

(22) PCT Filed: Oct. 4, 2022
(86) PCT No.: PCT/JP2022/037044

§ 371 Date: Apr. 24, 2024

(30) Foreign Application Priority Data
Oct. 25, 2021 (JP) 2021-173754

(51) Int. Cl. H02G 3/04; B60R 16/02; H01R 13/58

(52) U.S. Cl. CPC H02G 3/0418; B60R 16/0215; H01R 13/5841

(57) ABSTRACT

A wiring member includes: a connector that is to be connected to a movable part and moves along with movement of the movable part; an electrical wire that extends out of the connector; a protective member that covers the electrical wire; and a connector cover that covers the connector, the protective member, and a portion of the electrical wire between the connector and the protective member. The connector cover moves integrally with the connector and is movable relative to the protective member. The dimension of overlap between the connector cover and the protective member in the extending direction of the electrical wire is greater than or equal to the amount of movement of the movable part.

### CROSS-REFERENCE TO RELATED APPLICATIONS

This application is the U.S. national stage of PCT/JP2022/037044 filed on Oct. 4, 2022, which claims priority of Japanese Patent Application No. JP 2021-173754 filed on Oct. 25, 2021, the contents of which are incorporated herein.

### TECHNICAL FIELD

The present disclosure relates to a wiring member.

### BACKGROUND

JP 2012-234659A discloses a connector cover that is coupled to the electrical wire connection side of a connector. The connector cover is provided with a corrugated tube outer fitting part. The peak and valley parts of a corrugated tube covering the electrical wire are fitted to the corrugated tube outer fitting part.

The connector cover in JP 2012-234659A is coupled to the connector and the corrugated tube. Therefore, when the connector is pulled, the connector cover and the corrugated tube are also pulled so that the corrugated tube is less prone to come out of the connector cover.

A connector and a protective member may not be coupled via a connector cover. In this case as well, it is desired to suppress the case where the protective member comes out of the connector cover when the connector is pulled.

In view of this, an object of the present disclosure is to provide a technology for, even if a connector and a protective member are not coupled via a connector cover, suppressing the case where the protective member comes out of the connector cover when the connector is pulled.

### SUMMARY

A wiring member of the present disclosure is a wiring member connectable to a movable part of a movable apparatus provided in a vehicle, the wiring member including: a connector configured to be connected to the movable part and move along with movement of the movable part; an electrical wire extending out of a back end portion of the connector; a protective member configured to cover the electrical wire at a position spaced apart from the connector along an extending direction of the electrical wire; and a connector cover configured to cover the back end portion of the connector, an end portion of the protective member, and a portion of the electrical wire between the connector and the protective member, wherein the connector cover moves integrally with the connector and is movable relative to the protective member, and a dimension of overlap between the connector cover and the protective member in the extending direction of the electrical wire is greater than or equal to an amount of movement of the movable part.

### Advantageous Effects

According to the present disclosure, even if a connector and a protective member are not coupled via a connector cover, it is possible to suppress the case where the protective member comes out of the connector cover when the connector is pulled.

### BRIEF DESCRIPTION OF DRAWINGS

FIG. 1 is a perspective view of a wiring member according to a first embodiment.

FIG. 2 is an exploded perspective view of the wiring member according to the first embodiment.

FIG. 3 is a plan view schematically illustrating the relationship between the wiring member and a movable apparatus.

FIG. 4 is a plan view schematically illustrating the relationship between the wiring member and the movable apparatus when a consumable member is worn out.

FIG. 5 is a plan view schematically illustrating the relationship between the wiring member and the movable apparatus when the consumable member is worn out.

FIG. 6 is a perspective view of a wiring member according to a second embodiment.

FIG. 7 is an exploded plan view of the wiring member according to the second embodiment.

### DETAILED DESCRIPTION OF PREFERRED EMBODIMENTS

First, embodiments of the present disclosure will be listed and described.

The following are aspects of a wiring member of the present disclosure.

The wiring member is a wiring member connectable to a movable part of a movable apparatus provided in a vehicle, the wiring member including: a connector configured to be connected to the movable part and move along with movement of the movable part; an electrical wire extending out of a back end portion of the connector; a protective member configured to cover the electrical wire at a position spaced apart from the connector along an extending direction of the electrical wire; and a connector cover configured to cover the back end portion of the connector, an end portion of the protective member, and a portion of the electrical wire between the connector and the protective member, wherein the connector cover moves integrally with the connector and is movable relative to the protective member, and a dimension of overlap between the connector cover and the protective member in the extending direction of the electrical wire is greater than or equal to an amount of movement of the movable part. Since the dimension of overlap between the connector cover and the protective member in the extending direction of the electrical wire is greater than or equal to the amount of movement of the movable part, even if the connector and the connector cover move along with movement of the movable part, it is possible to suppress case where the protective member comes out of the connector cover.

In the wiring member according to (1), a defined position fixed part may be provided at an intermediate portion of the wiring member along an extending direction of the wiring member, and the defined position fixed part being configured to be fixed at a defined position relative to the vehicle regardless of presence or absence of movement of the movable part. Accordingly, even if a portion on the connector side of the defined position fixed part moves, it is possible to suppress case where the protective member comes out of the connector cover.

In the wiring member according to (2), the defined position fixed part may be provided at a portion of the protective member that extends outside of the connector cover. Accordingly, the portion of the protective member that extends outside of the connector cover can be fixed at the defined position relative to the vehicle regardless of the presence or absence of movement of the movable part.

In the wiring member according to any one of (1) to (3), the movable apparatus may include a consumable member that becomes worn along as the vehicle is used, the amount of movement of the movable part may become larger as the consumable member becomes worn, and the dimension of overlap between the connector cover and the protective member in the extending direction of the electrical wire may be greater than or equal to the amount of movement of the movable part when the consumable member reaches a wear limit. Accordingly, even if the connector and the connector cover move along with movement of the movable part when the consumable member has reached the wear limit, it is possible to suppress case where the protective member comes out of the connector cover.

In the wiring member according to any one of (1) to (4), the protective member may have an outer surface that is shaped so as to be uniformly continuous in an axial direction, the connector cover may have a connector cover body and a projection that projects from the connector cover body toward the outer surface of the protective member, and at least either the protective member or the projection may elastically deform when the projection comes into contact with the outer surface of the protective member. This makes the protective member less prone to come out of the connector cover.

In the wiring member according to (5), the connector cover may have a hole formed around a coupling part that couples the connector cover body to the projection, and the projection may be elastically deformable in inward and outward directions of the connector cover, via the coupling part. Accordingly, when the protective member is inserted into the connector cover and comes into contact with the projection, the projection is elastically deformable, and thus the protective member can be easily inserted into the connector cover.

In the wiring member according to any one of (1) to (6), the connector cover may have a water drainage hole. This suppresses the retention of water in the connector cover.

In the wiring member according to any one of (1) to (7), the dimension of overlap between the connector cover and the protective member in the extending direction of the electrical wire may be greater than or equal to a dimension of overlap between the connector and a counterpart connector of the movable part. Accordingly, even if the connector and the connector cover move when the connector is connected to the counterpart connector, it is possible to suppress case where the protective member comes out of the connector cover.

Specific examples of the wiring member in the present disclosure will be described below with reference to the drawings. It should be noted that the present disclosure is not limited to the examples herein, but rather is indicated by the scope of claims, and is intended to include all modifications within a meaning and scope equivalent to the scope of claims.

### First Embodiment

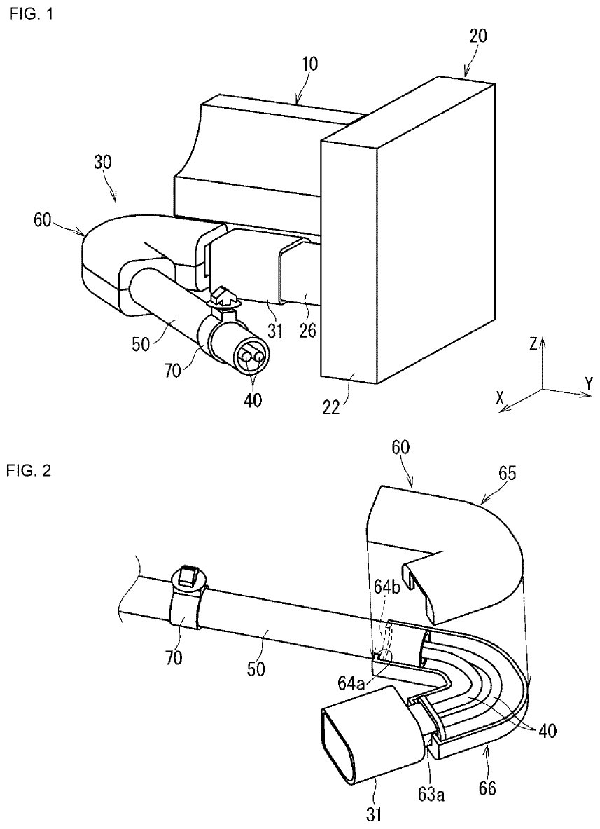

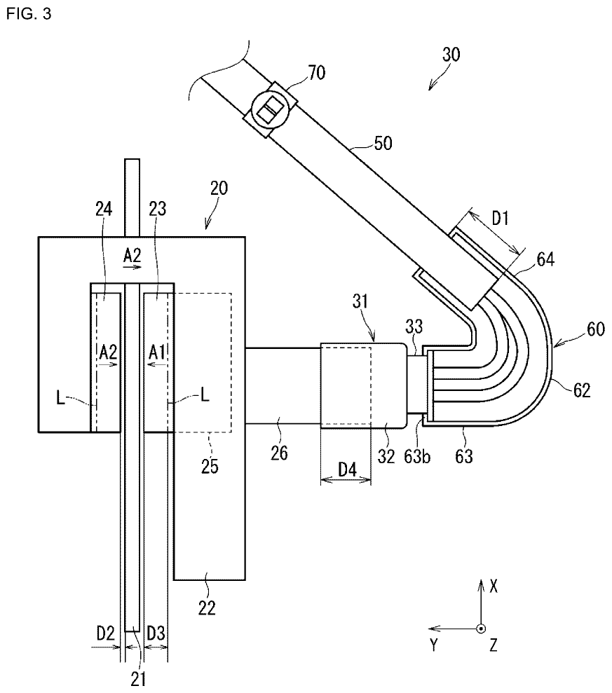

Hereinafter, a wiring member according to a first embodiment will be described. FIG. 1 is a perspective view of a wiring member 30 according to the first embodiment. FIG. 2 is an exploded perspective view of the wiring member 30 according to the first embodiment. FIG. 3 is a plan view schematically illustrating the relationship between the wiring member 30 and a movable apparatus 20. Referring to FIG. 1, the X direction is the front-back direction of a vehicle, the Y direction is the width direction of the vehicle, and the Z direction is the height direction of the vehicle.

The wiring member 30 is connected to the movable apparatus 20 provided in a vehicle. The wiring member 30 supplies electric power to the devices in the movable apparatus 20, or transmits signals to the devices in the movable apparatus 20 or signals from the devices in the movable apparatus 20. The movable apparatus 20 is electrically connected to a battery, an electronic control unit (ECU), or the like, via the wiring member 30. In the present embodiment, the movable apparatus 20 is assumed to be a brake device 20. The movable apparatus 20 may be an apparatus other than the brake device 20. In the present embodiment, the brake device 20 is assumed as a disc brake device. The brake device 20 may be a brake device 20 other than a disc brake device, such as a drum brake device.

The brake device 20 is provided at the underbody of the vehicle. At the underbody of the vehicle, the wheels are rotatably supported via a wheel support member 10. The brake device 20 includes a disc rotor 21, a brake caliper 22, a pair of brake pads 23 and 24, a brake piston 25, and the like. The disc rotor 21 is supported by the wheel support member 10 so as to rotate integrally with the wheels. The brake caliper 22 is supported by the wheel support member 10 so as to sandwich the disc rotor 21. The pair of brake pads 23 and 24 are supported by the brake caliper 22 so as to be capable of moving toward and away from the disc rotor 21. The disc rotor 21 is arranged so as to be positioned between the pair of brake pads 23 and 24. The brake piston 25 is built in the brake caliper 22. When the brake piston 25 is driven, the disc rotor 21 is clamped between the pair of brake pads 23 and 24, and braking is achieved by frictional force generated between the disc rotor 21 and the pair of brake pads 23 and 24. The method for driving the brake piston 25 may be any driving method such as a wire driving method, a fluid driving method, or an electric motor driving method, for example.

The wiring member 30 is connected to the movable part 22 in the movable apparatus 20. In the present embodiment, the movable part 22 is assumed to be the brake caliper 22. The brake caliper 22 is a floating caliper. The brake caliper 22 is movably supported by the wheel support member 10. The movement direction of the brake caliper 22 is parallel to the direction in which the brake pads 23 and 24 move toward and away from the disc rotor 21. The brake caliper 22 moves in cooperation with the brake pads 23 and 24 and the brake piston 25. When the brake piston 25 is driven, the inside brake pad 23 is moved in the direction shown by arrow A1 in FIG. 3 and is pressed against the inward-facing surface of the disc rotor 21. In reaction to this, the brake caliper 22 and the outside brake pad 24 are moved in the direction shown by arrow A2 in FIG. 3 and are pressed against the outward-facing surface of the disc rotor 21.

However, the brake caliper 22 may be fixed to the wheel support member 10. The brake caliper 22 may be an opposed-piston caliper or the like. In this case, the movable part 22 may not be the brake caliper 22. For example, the movable part may be the brake pads 23 and 24, the brake piston 25, or the like.

The wiring member 30 includes a connector 31, electrical wires 40, a protective member 50, and a connector cover 60.

The connector 31 is connected to the movable part 22. The connector 31 moves along with the movement of the movable part 22. In the present embodiment, the connector 31 is connected to a counterpart connector 26 provided on the brake caliper 22. The connector 31 includes a connector housing 32 and connector terminals, for example. The connector housing 32 holds the connector terminals at defined positions. The electrical wires 40 are connected to end portions on one side of the connector terminals. The other end portions of the connector terminals are connected to counterpart connector terminals of the counterpart connector 26. The portion of the connector 31 that is fitted to the counterpart connector 26 is the front end portion, and the portion on the opposite side is the back end portion. The front-back direction of the connector 31 is parallel to the fitting direction of the connector 31 and the counterpart connector 26. The fitting direction of the connector 31 and the counterpart connector 26 here is parallel to the movement direction of the movable part 22. However, the fitting direction of the connector 31 and the counterpart connector 26 may be a direction intersecting the movement direction of the movable part 22.

The electrical wires 40 extend out of the back end portion of the connector 31. The electrical wires 40 are each an insulating electrical wire that has a conductor core wire and an insulating coating. In the present embodiment, two electrical wires 40 are provided, but the number of electrical wires 40 may be one or three or more.

The protective member 50 covers the electrical wires 40 at a position spaced apart from the connector 31 along the extending direction of the electrical wires 40. The two electrical wires 40 are covered by the protective member 50. In the present embodiment, the protective member 50 has an outer surface that is shaped so as to be uniformly continuous in the axial direction. For example, the protective member 50 may be a hose, a sheath, or the like. The hose is a member that is molded of an elastic material such as rubber, separately from the electrical wires 40. The electrical wires 40 are inserted into the hose through one end portion and extend out of the hose through the other end portion. The sheath is a member that is molded around the electrical wires 40 by extrusion molding of a resin material or the like.

The connector cover 60 covers the back end portion of the connector 31, an end portion of the protective member 50, and the portion of the electrical wires 40 between the connector 31 and the protective member 50. The connector cover 60 includes a first opening part 63a and a second opening part 64a. The connector 31 extends from the first opening part 63a to the outside of the connector cover 60. The electrical wires 40 extend from the second opening part 64a to the outside of the connector cover 60. The connector cover 60 has a passage part through which the electrical wires 40 pass between the first opening part 63a and the second opening part 64a.

In the present example, the passage part of the connector cover 60 has a bent passage part 62. The bent passage part 62 extends so as to be bent along the extending direction of the electrical wires 40. The bent passage part 62 holds the electrical wires 40 in a bent state. The bent passage part 62 here holds the electrical wires 40 in a state of being bent at an angle larger than 90 degrees. The bent passage part 62 may hold the electrical wires 40 in a state of being bent at an angle of 90 degrees or an angle of being bent at an angle smaller than 90 degrees.

The passage part of the connector cover 60 further has a first straight passage part 63 and a second straight passage part 64. The first opening part 63a is provided at one end portion of the first straight passage part 63. The second opening part 64a is provided at one end portion of the second straight passage part 64. The bent passage part 62 connects the other end portion of the first straight passage part 63 to the other end portion of the second straight passage part 64. The first straight passage part 63 and the second straight passage part 64 extend in directions intersecting each other.

However, the passage part of the connector cover 60 may not have the bent passage part 62. For example, the passage part of the connector cover 60 may extend in a straight line from the first opening part 63a to the second opening part 64a. In addition, the passage part of the connector cover 60 may not have either the first straight passage part 63 or the second straight passage part 64.

The connector cover 60 moves integrally with the connector 31. The connector 31 and the connector cover 60 engage with each other in the front-back direction of the connector 31. The front-back direction of the connector 31 is parallel to the extending direction of the first straight passage part 63. The connector housing 32 has an annular groove 33 provided on the outer surface of the back end portion. The annular groove 33 extends around an axis that extends along the front-back direction of the connector housing 32. The inner surfaces of the annular groove 33 include a backward-facing surface and a forward-facing surface that are opposite to each other along the front-back direction of the connector housing 32. The first opening part 63a of the connector cover 60 has a fitting wall part 63b to fit into the annular groove 33. When the connector 31 is pulled forward (the direction shown by arrow A1 in FIG. 3 in this example), the forward-facing surface presses the fitting wall part 63b so that the connector cover 60 moves integrally with the connector 31. When the connector 31 is pulled backward (the direction shown by arrow A2 in FIG. 3 in this example), the backward-facing surface presses the fitting wall part 63b so that the connector cover 60 moves integrally with the connector 31.

An end edge of the protective member 50 fits into the second straight passage part 64 or a portion of the bent passage part 62 close to the second straight passage part 64. The protective member 50 extends as straight as possible in the connector cover 60. The protective member 50 may extend in the connector cover 60 in a curve along the bent passage part 62.

The connector cover 60 can move relative to the protective member 50. The second opening part 64a has a protruding wall part 64b that protrudes toward the protective member 50 to narrow the second opening part 64a. The second opening part 64a is formed in a shape (a circular shape in this example) that corresponds to the outer surface of the protective member 50. The second opening part 64a is formed with a size that corresponds to the outer surface of the protective member 50 (the same size in this example). The protective member 50 can move in a direction of being inserted into or removed from the connector cover 60 through the second opening part 64a.

As illustrated in FIG. 2, the connector cover 60 includes a first cover part 65 and a second cover part 66. The first cover part 65 and the second cover part 66 each have a shape of a half of the connector cover 60. The first cover part 65 and the second cover part 66 are combined to form the connector cover 60. The first cover part 65 and the second cover part 66 may be maintained in the combined state by engaging a locking portion provided in the first cover part 65 and a locked portion provided in the second cover part 66. The first cover part 65 and the second cover part 66 may be coupled via a hinge so as to be openable and closable.

The dimension of overlap between the connector cover 60 and the protective member 50 in the extending direction of the electrical wires 40 is greater than or equal to the amount of movement of the movable part 22. Referring to FIG. 3, a dimension D1 is the dimension of overlap between the connector cover 60 and the protective member 50 in the extending direction of the electrical wires 40. The dimension D1 is greater than or equal to the amount of movement of the movable part 22. The dimension D1 may be larger than the amount of movement of the movable part 22. If the dimension D1 is larger than the amount of movement of the movable part 22, the difference between the dimension D1 and the amount of movement of the movable part 22 is a margin. The margin may be 1 mm to 20 mm, for example.

In the present embodiment, the amount of movement of the movable part 22 includes the amount of movement of the brake caliper 22 when the brake device 20 is activated. Referring to FIG. 3, a dimension D2 is a clearance between the disc rotor 21 and the brake pads 23 and 24 when the brake device 20 is not activated, and is the amount of movement of the brake caliper 22 when the brake device 20 is activated. The dimension D1 is greater than or equal to the dimension D2. As described above, the inside brake pad 23 is pressed by the brake piston 25 and moved by the dimension D2 leftward in FIG. 3, and comes into contact with the disc rotor 21. In reaction to this, the outside brake pad 24 and the brake caliper 22 move by the dimension D2 rightward in FIG. 3. Accordingly, the connector 31 and the connector cover 60 also move by the dimension D2 rightward in FIG. 3. As a result, the protective member 50 moves relatively in a direction of coming out of the connector cover 60. In this case as well, since the dimension D1 is greater than or equal to the dimension D2, the case where the protective member 50 comes out of the connector cover 60 is suppressed.

In an intermediate portion of the wiring member 30 along the extending direction, a defined position fixed part 70 is provided so as to be fixed at a defined position relative to the vehicle regardless of the presence or absence of movement of the movable part 22. The portion of the wiring member 30 on the connector 31 side of the defined position fixed part 70 moves along with movement of the movable part 22. As the movable part 22 moves, the position of the connector 31 changes relative to the position of the defined position fixed part 70. The defined position fixed part 70 may be fixed to a member supporting the movable apparatus 20 such as the wheel support member 10, for example.

In the present embodiment, the defined position fixed part 70 is formed by attaching a band clip. The defined position fixed part 70 may be formed by attaching a clip other than a band clip, such as a tape-winding clip or a bracket.

In the present embodiment, the defined position fixed part 70 is provided at a portion of the protective member 50 that extends outside of the connector cover 60. The position of the defined position fixed part 70 may be any position in the portion of the electrical wires 40 that extends outside of the second opening part 64a of the connector cover 60. For example, the defined position fixed part 70 may be provided at a portion of the electrical wires 40 that extends out of the protective member 50. In this case, the electrical wires 40 and the protective member 50 may be preferably fixed by taping or the like. The portion of the protective member 50 provided with the defined position fixed part 70 is fixed at a defined position relative to the vehicle regardless of the presence or absence of movement of the movable part 22. The portion of the protective member 50 provided with the defined position fixed part 70 may be regarded as a fixed end, and the portion of the protective member 50 on the connector cover 60 side of the defined position fixed part 70 may be regarded as a free end.

The portion of the electrical wires 40 provided with the defined position fixed part 70 may be made immovable relative to the protective member 50 in the axial direction of the protective member 50. For example, the electrical wires 40 may be made immovable relative to the protective member 50 in the axial direction of the protective member 50, by tightly tying the electrical wires 40 and the protective member 50 with the band part of the band clip, for example. The portion of the electrical wires 40 provided with the defined position fixed part 70 may be made movable relative to the protective member 50 in the axial direction of the protective member 50. For example, the electrical wires 40 may be made movable relative to the protective member 50 in the axial direction of the protective member 50 by loosely tying the electrical wires 40 and the protective member 50 with the band part of the band clip, for example.

In the present embodiment, the movable apparatus 20 includes consumable members that become worn as vehicle the vehicle is used. As the wearing of the consumable members progresses, the amount of movement of the movable part 22 increases. In the brake device 20, the consumable members are the brake pads 23 and 24, for example. The consumable members 23 and 24 may have a preset wear limit. The wear limit is a value set for the consumable members 23 and 24 as a guide for replacement of the consumable members 23 and 24. In FIG. 3, virtual lines L are lines indicating the wear limit. In FIG. 3, a dimension D3 indicates the remaining amount of the consumable members 23 and 24 before the wear limit is reached. The lines L indicating the wear limit may not be provided, and a sensor or the like may be provided instead. When the consumable members 23 and 24 reach the wear limit, the user of the vehicle may be notified that the consumable members 23 and 24 have reached the wear limit.

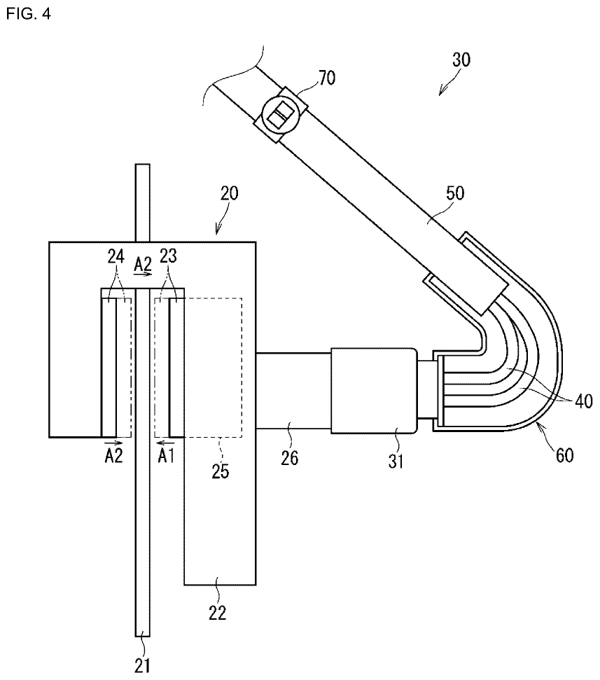

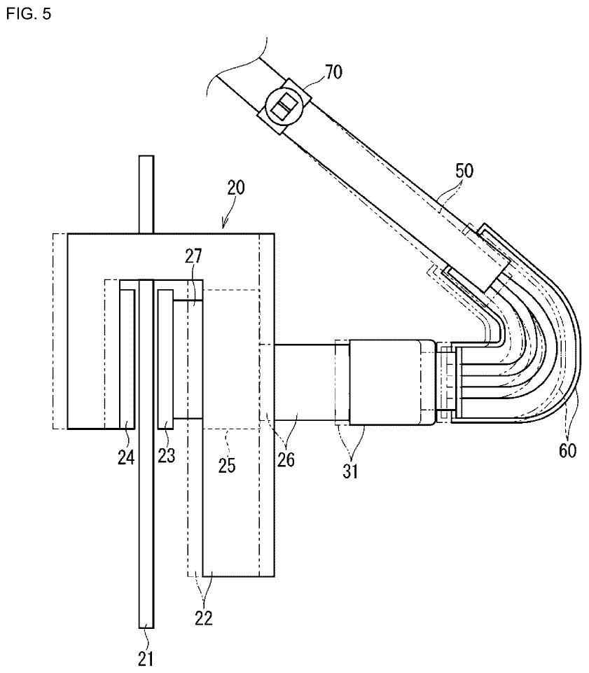

The relationship between the wiring member 30 and the movable apparatus 20 when the consumable members 23 and 24 become worn will be described below with reference to FIGS. 4 and 5 as well. FIGS. 4 and 5 are plan views schematically illustrating the relationship between the wiring member 30 and the movable apparatus 20 when the consumable members 23 and 24 become worn. In FIG. 4, the brake pads 23 and 24 shown by virtual lines are in the unworn state, and the brake pads 23 and 24 shown by solid lines are in the worn state. In FIG. 5, the members shown by virtual lines have not been moved by an adjustment mechanism 27, and the members shown by solid lines have been moved by the adjustment mechanism 27.

In the brake device 20, as the brake pads 23 and 24 become worn, the distance between the brake pads 23 and 24 and the disc rotor 21 increases due to the wear unless some sort of countermeasure is taken. Therefore, when the brake pads 23 and 24 become worn and the distance between the brake pads 23 and 24 and the disc rotor 21 increases, the stroke of the piston (the dimension D2) increases, and the amount of movement of the movable part 22 increases.

In general, in the brake device 20, the stroke of the brake piston 25 (the distance between the brake pads 23 and 24 and the disc rotor 21) is adjusted by the adjustment mechanism 27 so as to be constant regardless of the wear volume of the brake pads 23 and 24. As the brake pads 23 and 24 become worn, the inside brake pad 23 is moved by an amount corresponding to the wear volume by the adjustment mechanism 27 in a direction of arrow A1 in FIG. 4, and the outside brake pad 24 is moved by an amount corresponding to the wear volume by the adjustment mechanism 27 in a direction of arrow A2 in FIG. 4. This keeps a constant distance between the pair of brake pads 23 and 24 and the disc rotor 21. At this time, as illustrated in FIG. 5, the brake caliper 22 also moves in the direction of arrow A2 in FIG. 4 in conjunction with the brake pad 24. Therefore, the amount of movement of the brake caliper 22 as the brake pads 23 and 24 become worn is obtained by adding the amount of movement of the position of the brake caliper 22 caused by wearing of the brake pads 23 and 24 to the predetermined stroke (dimension D2) of the brake piston 25. The dimension D3 indicating the remaining amount of the brake pads 23 and 24 before reaching the wear limit is taken into consideration in the amount of movement of the brake caliper 22 that will result from the future wearing of the brake pads 23 and 24. The sum of the dimension D2 and the dimension D3 is the amount of movement of the movable part 22 when the consumable members 23 and 24 have reached the wear limit. Due to the dimension D1 being greater than or equal to the sum of the dimension D2 and the dimension D3, the protective member 50 is less prone to come out of the connector cover 60 even if the brake pads 23 and 24 become worn and reach the wear limit in the future. Referring to FIG. 3, a dimension D4 is the dimension of overlap between

the connector 31 and the counterpart connector 26. The dimension of overlap between the connector 31 and the counterpart connector 26 indicates the amount of insertion of a male connector into a female connector, for example. The dimension D1 is greater than or equal to the dimension D4. Accordingly, even if the connector 31 is pulled while the connector 31 and the counterpart connector 26 are fitted together, the protective member 50 is not prone to come out of the connector cover 60.

According to the wiring member 30 configured as described above, the dimension D1 of overlap between the connector cover 60 and the protective member 50 in the extending direction of the electrical wire 40 is greater than or equal to the amount of movement of the movable apparatus 20 (the dimension D2 or the sum of the dimension D2 and the dimension D3 in this example), and therefore even if the connector 31 and the connector cover 60 move along with movement of the movable apparatus 20, it is possible to suppress the case where the protective member 50 comes out of the connector cover 60.

The defined position fixed part 70 is provided at an intermediate portion of the wiring member 30 along the extending direction, and the defined position fixed part 70 is fixed at a defined position relative to the vehicle regardless of the presence or absence of movement of the movable apparatus 20. Accordingly, even if a portion on the connector 31 side of the defined position fixed part 70 moves, it is possible to suppress the case where the protective member 50 comes out of the connector cover 60.

The defined position fixed part 70 is provided on a portion of the protective member 50 that extends outside of the connector cover 60. Accordingly, the portion of the protective member 50 that extends outside of the connector cover 60 can be fixed at the defined position relative to the vehicle regardless of the presence or absence of movement of the movable apparatus 20.

The dimension D1 of overlap between the connector cover 60 and the protective member 50 in the extending direction of the electrical wire 40 is greater than or equal to the amount of movement of the movable part 22 (the sum of the dimension D2 and the dimension D3 in this example) when the consumable members 23 and 24 have reached the wear limit. Accordingly, even if the connector 31 and the connector cover 60 move when the consumable members 23 and 24 have reached the wear limit, it is possible to suppress the case where the protective member 50 comes out of the connector cover 60.

The dimension D1 of the overlap between the connector cover 60 and the protective member 50 in the extending direction of the electrical wire 40 is greater than or equal to the dimension D4 of the fit between the connector 31 and the counterpart connector 26. Accordingly, even if the connector 31 and the connector cover 60 move when the connector 31 is connected to the counterpart connector 26, it is possible to suppress case where the protective member 50 comes out of the connector cover 60.

### Second Embodiment

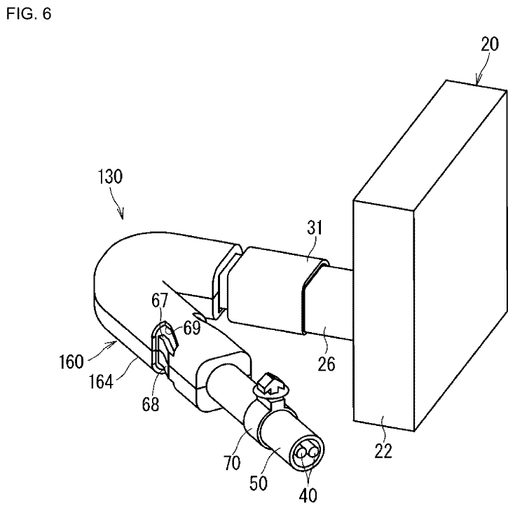

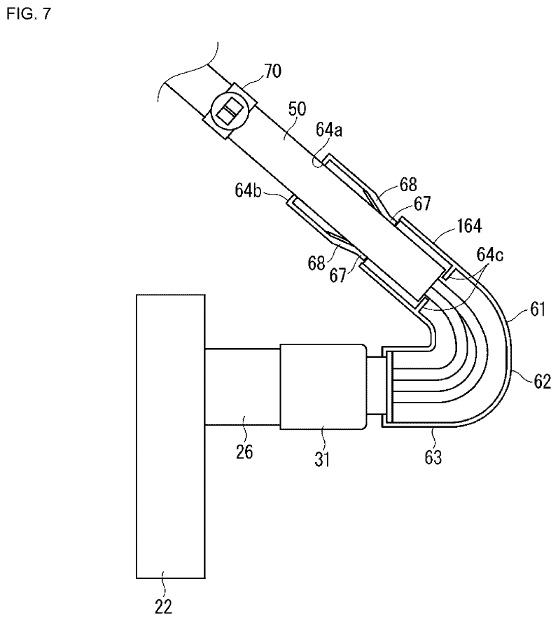

A wiring member according to a second embodiment will be described below. FIG. 6 is a perspective view of a wiring member 130 according to the second embodiment. FIG. 7 is an exploded plan view of the wiring member 130 according to the second embodiment. In the description of the present embodiment, constituent elements similar to those described above will be given identical reference signs, and description thereof will be omitted.

In the wiring member 130, the shape of a connector cover 160 is different from the shape of the connector cover 60 of the wiring member 30. Specifically, the connector cover 160 has a connector cover body 61 and projections 67. The projections 67 project from the connector cover body 61 toward the outer surface of the protective member 50. The projections 67 come into contact with the outer surface of the protective member 50, and at least either the protective member 50 or the projections 67 elastically deform. Accordingly, the protective member 50 is less prone to come out of the connector cover 60.

The connector cover body 61 constitutes a passage part, and includes a bent passage part 62, a first straight passage part 63, and a second straight passage part 164. The projections 67 are provided in the second straight passage part 164. In the present embodiment, a pair of projections 67 are provided. The protective member 50 is positioned between the pair of projections 67. The pair of projections 67 clamp the protective member 50 therebetween.

In the present embodiment, the connector cover 160 has holes 69 formed around coupling parts 68 that couple the connector cover body 61 to the projections 67. The projections 67 are elastically deformable in the inward and outward directions of the connector cover 160 via the coupling parts 68. Accordingly, when the protective member 50 is put into the connector cover 160 and comes into contact with the projections 67, the projections 67 are elastically deformable and thus the protective member 50 can be easily inserted into the connector cover 160. However, the projections 67 may undergo less elastic deformation than the protective member 50.

The holes 69 are also used as release holes for vertically removing dies for molding the first cover part 65 while providing the projections 67 and the coupling parts 68.

The leading end portions of the projections 67 extend along the outer surface of the protective member 50. Each projection 67 has a guide surface closer to the coupling part 68 than the leading end portion of the projection 67. The guide surface is inclined so as to move away from the protective member 50 while extending from the leading end of the projection 67 toward the second opening part 64a.

The connector cover 60 has water drainage holes 69. This suppresses the retention of water inside the connector cover 60. In the present embodiment, the holes 69 around the coupling parts 68 that couple the connector cover body 61 to the projections 67 constitute the water drainage holes 69.

In the present embodiment, the second straight passage part 164 is longer than the second straight passage part 64. This increases the dimension D1 of overlap between the connector cover 160 and the protective member 50 in the extending direction of the electrical wires 40. However, in the connector cover 160, the second straight passage part 164 may not be lengthened.

In the present embodiment, the second straight passage part 164 has a restriction wall part 64c closer to the bent passage part 62 than the projections 67 are. The restriction wall part 64c protrudes toward the inside of the second straight passage part 164. The restriction wall part 64c is smaller than the protective member 50. The leading end surface of the protective member 50 abuts against the restriction wall part 64c to suppress further insertion into the connector cover 160. However, the connector cover 160 may not be provided with the restriction wall part 64c.

In the present embodiment, the connector cover 60 includes both the projections 67 and the water drainage holes 69. However, this configuration is not essential. The connector cover 60 may include only either the projections 67 or the holes 69.

The configurations in the foregoing embodiments and modifications described above can be combined as appropriate as long as no contradiction arises.

1. A wiring member connectable to a movable part of a movable apparatus provided in a vehicle, the wiring member comprising:
a connector configured to be connected to the movable part and move along with movement of the movable part;
an electrical wire extending out of a back end portion of the connector;
a protective member configured to cover the electrical wire at a position spaced apart from the connector along an extending direction of the electrical wire; and
a connector cover configured to cover the back end portion of the connector, an end portion of the protective member, and a portion of the electrical wire between the connector and the protective member,
wherein the connector cover moves integrally with the connector and is movable relative to the protective member, and
a dimension of overlap between the connector cover and the protective member in the extending direction of the electrical wire is greater than or equal to an amount of movement of the movable part.

2. The wiring member according to claim 1, wherein a defined position fixed part is provided at an intermediate portion of the wiring member along an extending direction of the wiring member, the defined position fixed part being configured to be fixed at a defined position relative to the vehicle regardless of presence or absence of movement of the movable part.

3. The wiring member according to claim 2, wherein the defined position fixed part is provided at a portion of the protective member that extends outside of the connector cover.

4. The wiring member according to claim 1,
wherein the movable apparatus includes a consumable member that becomes worn as the vehicle is used,
the amount of movement of the movable part becomes larger as wearing of the consumable member progresses, and
the dimension of overlap between the connector cover and the protective member in the extending direction of the electrical wire is greater than or equal to the amount of movement of the movable part when the consumable member reaches a wear limit.

5. The wiring member according to claim 1,
wherein the protective member has an outer surface that is shaped so as to be uniformly continuous in an axial direction,
the connector cover has a connector cover body and a projection that projects from the connector cover body toward the outer surface of the protective member, and
at least either the protective member or the projection elastically deforms when the projection comes into contact with the outer surface of the protective member.

6. The wiring member according to claim 5,
wherein the connector cover has a hole formed around a coupling part that couples the connector cover body to the projection, and
the projection is elastically deformable in inward and outward directions of the connector cover, via the coupling part.

7. The wiring member according to claim 1, wherein the connector cover has a water drainage hole.

8. The wiring member according to claim 1, wherein the dimension of overlap between the connector cover and the protective member in the extending direction of the electrical wire is greater than or equal to a dimension of overlap between the connector and a counterpart connector of the movable part.
